(19) United States
(12) Patent Application Publication
(10) Pub. No.: US 2015/0340169 A1
(43) Pub. Date: Nov. 26, 2015

(54) SUPERCAPACITOR

(71) Applicant: BRUNEL UNIVERSITY, Uxbridge Middlesex (GB)

(72) Inventors: Fulian QIU, Uxbridge, Middlesex (GB); David Jonathan HARRISON, Uxbridge, Middlesex (GB); John Richard FYSON, Uxbridge, Middlesex (GB); Darren John SOUTHEE, Shepshed, Leicester (GB)

(73) Assignee: Brunel University, Uxbridge, Middlesex (GB)

(21) Appl. No.: 14/761,480

(22) PCT Filed: Mar. 6, 2014
(86) PCT No.: PCT/GB2014/050657

§ 371 Date: Jul. 16, 2015

(30) Foreign Application Priority Data
Mar. 6, 2013 (GB) 1304033.2

(51) Int. Cl. H01G 11/04; H01G 11/86; H01G 11/44; H01G 11/34; H01G 11/10; H01G 11/38

(52) U.S. Cl. CPC H01G 11/04; H01G 11/10; H01G 11/38; H01G 11/44; H01G 11/34; H01G 11/86

(57) ABSTRACT

A supercapacitor comprises a single core (preferably an electrically conducting fibre core) having sequential coaxial layers of: (i) a first electrode, (ii) a gelled electrolyte which functions as a separator for the supercapacitor, (iii) a second electrode, and (iv) a conductor for collecting current. A further supercapacitor layer can be provided. The supercapacitor fibre can be incorporated into fabric to form articles of clothing.

### TECHINAL FIELD

The present invention relates to a single fibre or thread supercapacitor, and in particular to a single fibre supercapacitor which is sufficiently flexible to be incorporated into textile material to enable the production of so-called ‘smart’ clothing. Supercapacitors in accordance with the invention can also be combined with photovoltaic fibres to produce a textile for electrical energy generation and storage.

### BACKGROUND ART

Capacitors are components which store energy in an electrical field. Traditional capacitors are formed of two conductive plates separated by a dielectric (an insulating layer). When a potential difference is applied across the plates, one of them becomes positively charged and the other negatively charged and energy is stored in the electrostatic field.

Supercapacitors (also known as ultracapacitors) are a type of capacitor which does not have a conventional solid dielectric, but instead employ an electrolyte between two electrodes in which virtual plates are formed by the action of the electrodes on the electrolyte. Specifically, a double layer is formed between the surface of the electrode and the electrolyte, and there is a charge separation across this double layer which enables the electrostatic storage of electrical energy. This type of supercapacitor is therefore known as an “electric double-layer capacitor”. Conventional electric double-layer capacitors employ a separator to prevent the electrodes from contacting each other.

Another type of supercapacitor is the pseudocapacitor, in which the electrolyte takes part in redox reactions at the surface of the electrodes to result in a reversible faradaic charge transfer which enables energy storage.

Electrical energy can also be stored and delivered from batteries, which convert chemical energy to electrical energy by means of a redox reaction in the battery cells. Conventionally, batteries tend to be better at storing energy than capacitors (i.e. have a higher energy density) whereas capacitors tend to be better at delivering energy quickly than batteries (i.e. a higher power density). Modern rechargeable batteries such as lithium ion batteries are lighter than conventional batteries and retain a higher charge over a longer time period.

Electrochemical supercapacitors have many advantages over Li ion batteries with high power density, easy fabrication, low cost, long life time and a good safety record. In comparison to electrostatic capacitors, they have high energy storage ability. Many researches on supercapacitors have focused on applications in electric vehicles, hybrid electric vehicles and backup energy sources.

With the rapid development of the multifunction portable electronics and energy harvesting devices such as solar cells, it is difficult to integrate old fashioned bulky supercapacitors into these smart and textile electronics. Miniaturised, flexible and weaveable supercapacitors are in high demand and have been investigated. Recently there are some reports on fibre supercapacitors, these included those using carbon nanotube fibres (A. B. Dalton, S. Collins, E. Munoz, J. M. Razal, V. H. Ebron, J. P. Ferraris, J. N. Coleman, B. G. Kim and R. H. Baughman, Nature, 2003, 423, 703-703), ZnO—gold nanowires (J. Bae, M. Song, Y. Park, J. Kim, M. Liu and Z. Wang, Angew. Chem., Int. Ed., 2011, 50, 1683-1687), Chinese ink coated nickel wires (Y. P. Fu, X. Cai, H. W. Wu, Z. B. Lv, S. C. Hou, M. Peng, X. Yu and D. C. Zou, Advanced Materials, 2012, 24, 5713-5718), and a carbon nanotube-Ti nanotube fibre supercapacitor integrated with photoelectrical fibre (T. Chen, L. Qiu, Z. Yang, Z. Cai, J. Ren, H. Li, H. Lin, X. Sun and H. Peng, Angew. Chem., Int. Ed., 2012, 51, 11977-80). For all these fibre devices, two fibres were arranged either helically or in parallel and special care was taken to avoid short circuits.

Other supercapacitors are disclosed in JP 2010021168 A (Komatsu) and US 2005/040374 A1(Chittibabu).

For the reported 1D supercapacitors, PVA-H₃PO₄ served as electrolyte. Their applications have been hindered by an intrinsic potential window of 1V as almost all these devices operated at below 1V to avoid irreversible electrochemical reactions.

### SUMMARY OF THE PRESENT INVENTION

In accordance with a first aspect of the present invention, there is provided a supercapacitor comprising a single core having sequential coaxial layers of:
(i) a first electrode,
(ii) a gelled electrolyte which functions as a separator for the supercapacitor,
(iii) a second electrode, and
(iv) a first conductor for collecting current.

Preferably, the core is electrically conductive. If it is not then the first electrode must be electrically conducting. The core may be a fibre core.

The supercapacitor has a single core in contrast to prior art capacitors which comprise two parallel wires.

In a preferred embodiment, the layers extend around the entire circumference of the core, which may be formed from a metal (such as stainless steel), a polymer, carbon, or any combination thereof.

The surprising realisation of the present inventors is that if a gelled capacitor is employed, there is no need to employ a separate separator. This enables a single fibre supercapacitor to be formed, for example by dip-coating the coaxial layers onto the electrically conducting core. The absence of a separator (which would conventionally be formed from filter paper or a porous polymer for example) enables the supercapacitor to be formed around a core and avoids problems with the separator breaking when the fibre is flexed. Accordingly, in a preferred embodiment the supercapacitor does not have a conventional separator.

Gelled electrolytes are known (see for example Maher F. El-Kady, Veronica Strong, Sergey Dubin, Richard B. Kaner, Science, 2012, 335, 1326), but in a conventional flat plate electrochemical capacitor not a coaxial single fibre supercapacitor.

There have been were two previous attempts to make coaxial electrostatic capacitors but either they have very low capacitance or required delicate procedures, which have limited their applications (J. A. F. Gu, S. Gorgutsa and M. Skorobogatiy, Appl. Phys. Left., 2010, 97, 3; J. F. Gu, S. Gorgutsa and M. Skorobogatiy, Smart Mater. Struct., 2010, 19, 13; Z. Liu, R. Vajtai, F. Banhart, P. Sharma, J. Lou, P. Ajayan, Y. Zhan, G. Shi, S. Moldovan, M. Gharbi, L. Song, L. Ma, W. Gao and J. Huang, Nature communications, 2012, 3).

In a further embodiment, the supercapacitor may have the following additional layers:
(v) a third electrode,
(vi) second gelled electrolyte which functions as a separator,
(vii) a fourth electrode, and
(viii) a second conductor for collecting current.

The further electrodes, electrolytes and conductors may be formed from the same materials or different materials depending on the desired application.

This double layer single fibre supercapacitor has been found to exhibit a larger potential window with high energy per unit length with comparison to those of single supercapacitors. In particular, an extended electrochemical potential window of 2V and higher energy per length of thread were obtained when PVA-H₃PO₄ was employed as the electrolyte.

The double layer supercapacitor of the present invention is particularly advantageous as two capacitive layers can be operated as two single supercapacitors in series or in parallel.

The provision of two supercapacitors in one device is less bulky than providing two devices which is advantageous when it comes to applications in which space is at a premium.

In accordance with a second aspect of the present invention, there is provided a method of making a single fibre supercapacitor as defined above, wherein said layers are formed on the core by means of (preferably) dip coating, but alternatively spray coating, brush coating, extrusion coating, electrodeposition, plasma coating, curtain coating, vacuum deposition or any combination thereof.

Surprisingly, it has been found that these methods enable the manufacture of a single fibre supercapacitor which employs a gelled electrolyte and avoids the need for a separate separator layer. The gelled electrolyte is formed from a polymer and a conducting liquid. The gel electrolyte might be aqueous or organic based, or based on an ionic liquid. An example of an aqueous based gel electrolyte would be a mixture of PVA, (Poly(vinyl alcohol) phosphoric acid and water. An example of an organic gel electrolyte would be PMMA, (Poly(methyl methacrylate), ethylene carbonate, propylene carbonate, lithium tetrafluoroborate in THF, Tetrahydrofuran. An example of an ionic liquid based gel electrolyte would be a mixture of PVDF-HEP, (Poly(vinylidene fluoride-co-hexafluoropropylene) and [Bmim]Nf2, (1-Butyl-3-methylimidazolium trifluoromethanesulfonate) and acetone.

In accordance with a third aspect of the present invention, there is provided a single fibre supercapacitor, comprising an electrically conducting core having sequential coaxial layers of:
(i) a first electrode,
(ii) a gelled electrolyte which functions as a separator for the supercapacitor,
(iii) a second electrode, and
(iv) a conductor for collecting current.

### BRIEF DESCRIPTION OF THE DRAWINGS

A number of preferred embodiments of the invention will now be described, with reference to the accompanying drawings, in which:

FIG. 1 is a schematic diagram of a coaxial signal fibre supercapacitor in accordance with the invention showing four coating layers;

FIG. 2 includes SEM images of a coaxial signal fibre supercapacitor in accordance with the invention showing (a) the Chinese ink layer, (b) the active carbon layer and (c) a cross section of the supercapacitor;

FIG. 3 includes graphs showing the performance of a coaxial signal fibre supercapacitor in accordance with the invention showing (a) cyclic voltammograms recorded at different scan rates and (b) galvanostatic charge-discharge curve recorded at 40 μA for a 2.5 cm long CSFS;

FIG. 4 is a graph showing electrochemical impedance spectra of a coaxial signal fibre supercapacitor in accordance with the invention measured for a frequency ranged from 100 kHz to 0.01 Hz with a 10 mV AC bias for a 2.5 cm long CSFS;

FIG. 5 is a schematic drawing of the dip-coating apparatus for preparing the supercapacitors of the present invention;

FIG. 6 is a schematic diagram of a coaxial single fibre multiple capacitive layer supercapacitor in accordance with the invention showing eight coating layers;

FIG. 7 is a photo image (a) and SEM image (b) of a cross section of a supercapacitor in accordance with the invention;

FIG. 8 shows cyclic voltammograms recorded at 50 mV/s for 4 supercapacitors in accordance with the invention;

FIG. 9 shows four galvanostatic charge-discharge curves recorded for devices in accordance with the present invention; and

FIG. 10 is a Nyquist plot recorded for a supercapacitor in accordance with the invention.

### EXAMPLE 1

This relates to a coaxial single fibre single layer supercapacitor (CSFS) in accordance with the invention. Its capacitance and impedance were measured, and surface morphologies were investigated.

Experimental Section—Preparation of Coaxial Wire Supercapacitor

A 50 μm (in diameter) stainless steel wire was pre-treated using acetone for 10 minutes and 0.1M H₂SO₄ for 30 minutes in an ultrasonic water bath, rinsed using deionised water and dried in air.

A dip-coating method was used to coat Chinese ink, gel electrolyte, and an active carbon-gel layer onto the wire sequentially. Each coating of Chinese ink gave a layer of about 1.2 μm.

After it was dried in air, the electrode was dip-coated twice using gel electrolyte to form a separator. PVA-H₃PO₄ was used. When the gel is solidified, activated carbon slurry coating was conducted. The slurry was prepared using a composition of active carbon (AC): 5 wt % binder: solvent (1:1:4); the binder solution is 5 wt % PVA and 1M H₃PO₄in H₂O. Here H₃PO₄ works as electrolyte in out layer of the supercapacitor. Finally, a silver paint layer was coated onto the wire as an outside layer-current collector. All chemicals were purchased from Sigma-Aldrich, and used as received without further purification. Stainless steel was purchased from Advent Research Material, Oxford. Chinese ink was produced by Shanghai Ink Corporation.

Surface and cross section structures were examined using scanning electron microscope FEG-SEM (Supra 35VP Carl Zeiss, Germany); all electrochemical measurements were conducted with a two-electrode setup using electrochemical workstation VersaStat 3.0 (Princeston Applied Research). The electrochemical impedance measurements were performed over 100 KHz-0.01 Hz with a 10 mV bias.

Results

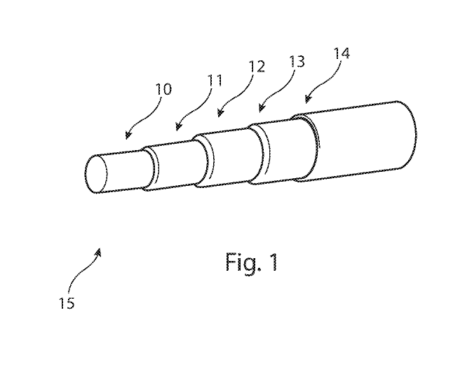

FIG. 1 shows a schematic of the CSFS 15. It consists of ink-gel-activated carbon (AC) in three active coating layers 11,12,13 and one silver paint layer 14 for current collector. A dip coating method was used to prepare the coated layers. The conductive core 10 is formed from a 50 μm stainless steel wire.

The first and third active layers were prepared using Chinese ink 11 and activated carbon slurry 13 respectively; they serve as two large surface area electrodes in the supercapacitor. The second layer 12 was prepared using a PVA-H₃PO₄-H₂O gel solution; this layer 12 serves as both the ion transport layer and separator between two electrodes 11,13.

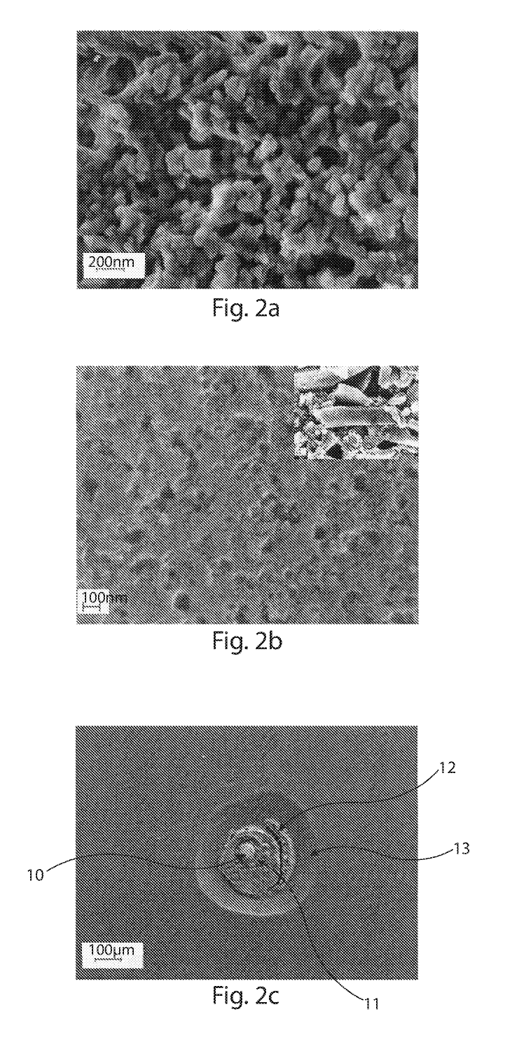

The surface morphologies of the two active layers 11,13 and the cross section structure of the device were examined using scanning electron microscope FEG-SEM (Supra 35VP Carl Zeiss, Germany) and are shown in FIG. 2. FIG. 2a shows the image of the Chinese ink coated layer 11. It can be seen that the porous ink layer was packed with about 50 nm carbon particles; the pore size is about 75 nm, which helps the electrolyte penetrate through the whole porous network. The porous activated carbon layer is composed of about 50 μm carbon short fibres as shown in FIG. 2b as inset. The carbon fibre was examined further at high magnification; it reveals that the carbon fibre has a lot of holes as shown in FIG. 2b , the diameter of holes is about 70 nm. This gives large internal area for storing charges. FIG. 2c shows a cross section image of the CSFS 15 . The sample was prepared by sealing a segment of the coaxial fibre supercapacitor in a liquid polymer mixture, and it was left for 24 hours for solidification; cut and then polished. As carbon layers are soft, and the gel electrolyte layer is flexible, the cross section was slightly distorted after polishing. The coating layers are relatively uniform as shown in FIG. 2c.

Average thicknesses are measured as about 25 μm, about 75 μm and about 85 μm for the ink 11, gel electrolyte 12 and activated carbon 13 layers respectively.

Electrochemical measurements were conducted with a two-electrode setup using an electrochemical workstation VersaStat 3.0 (Princeton Applied Research). For electrochemical impedance measurements, a frequency range of 100 kHz-0.01 Hz with a 10 mV bias was employed. A 2.5 cm long coaxial single fibre supercapacitor was used throughout the experiments.

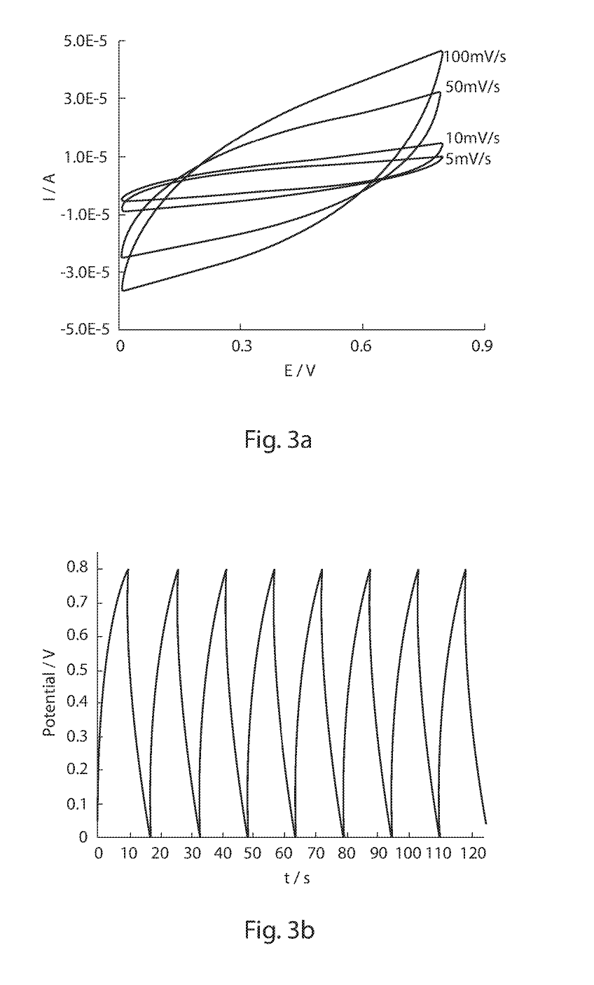

FIG. 3a shows typical cyclic voltammograms recorded at scan rates of 5, 10, 50 and 100 mV/s 2nd, 3rd and 4th scans are displayed in FIG. 3 for each case. It can be seen that consecutive scans are not distinguishable, which indicates the high stability of the device. High capacitance currents were also noted. Cyclic voltammograms were distorted from ideal square-box shape, this may result from ions' slow diffusion in porous carbon structure, high series resistance and high charging-discharging currents, and further examination using EIS is shown in a later text.

FIG. 3b shows a typical galvanostatic charge-discharge curve at a current of 40 μA. A sharp potential drop at an early stage of the discharge is due to an iR drop. The specific capacitance per unit length was obtained using the equation C_{L}=IΔt/(L(E−iR_{drop})), where/is the charge-discharge current (A); Δt, the discharge time (s); L, the supercapacitor length (cm); E, the potential window (V). The value of C_{L}was calculated as 0.1 mFcm^{31 1}. The specific capacitance per unit area was calculated using Cₛ=IΔt /(s(E−iR_{drop})) where s is the surface area calculated by multiplying length and circumference of the first active layer ink coating surface.

Unlike two fibre supercapacitors, the two electrodes have a different circumference interface with gel electrolyte. The radius of the first active layer surface is measured as 50 μm, the surface area of this layer was calculated as 0.0785 cm²; the specific areal capacitance is 3.18 mFcm⁻². This value is difficult to compare with reported values for two-fibre supercapacitors because different diameter fibres, and thickness of active coating layers were used; Areal specific capacitance in the range of 0.4-20.0 mFcm⁻² has been reported as different volume of active material used.

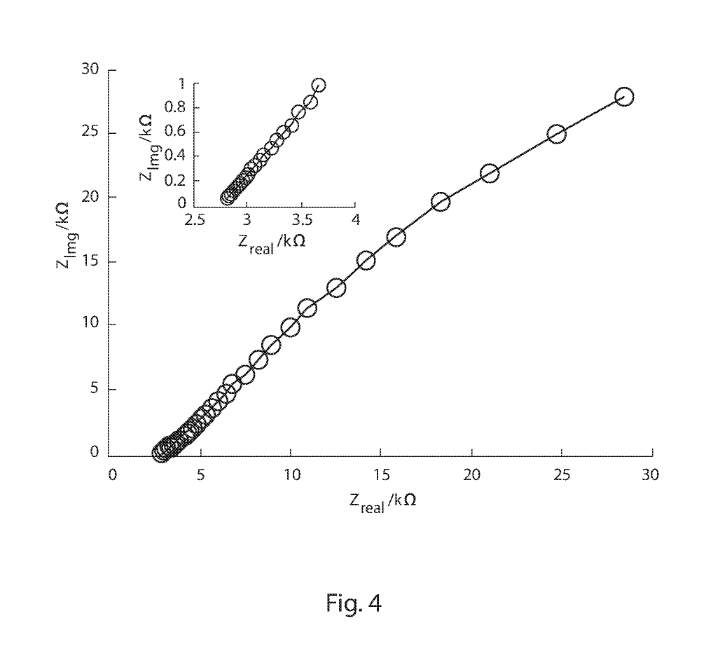

FIG. 4 shows the electrochemical impedance spectrum for a range of frequencies from 100 kHz down to 0.01 Hz using AC 10 mV potential modulation. Enlarged spectrum at high frequencies was inserted in FIG. 4. A pure capacitance trend was noted as the transmission line model as predicted; no semicircle shape at high frequency ranges was observed, which would result from interface processes of active layers and current collector, and porous carbon electronic structure. High series resistance of 2.85 kΩis obtained resulting from a thick gel electrolyte layer and poor conductivity in porous carbon layers; this shows consistency with cyclic voltammograms of a distorted box shape, and an iR drop in the discharge curve. High series resistance has also been reported for fibre supercapacitor with gel electrolyte.

EXAMPLE 2

This relates to a coaxial single fibre multiple capacitive layer supercapacitor in accordance with the invention. Its capacitance and impedance were measured, and surface morphologies were investigated.

In order to check that the rules for connecting capacitors in parallel or series are obeyed, two capacitive layers single fibre supercapacitor were fabricated and characterised. Their capacitances and electrochemical stability were studied. A dip coating method was employed for the fabrication of all the thread supercapacitors. A series of capacitive layers were coated onto conductive microwire or fibre sequentially using a dip coating method, each capacitive layer consists of ink-gel-ink-conductive paint layer.

Experimental Section—Preparation of Coaxial Wire Supercapacitor

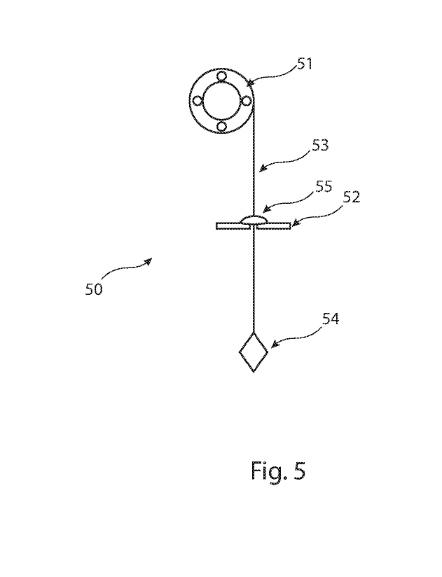

FIG. 5 shows the purpose-built dip coating setup 50 for making the supercapacitor. This setup consists of multi-speed controlled motor 51 and Perspex discs 52 of a radius of 1.5 cm or 1 cm diameter PTFE pipette reservoirs. In the centre of discs and the reservoirs, different sizes of sub-millimetre holes were machined using a laser cutting setup, which allows the core wire 53 through, and facilitate the dip coating processes. Holes of different diameters were created for different coating layers.

A pre-wired bobbin was fixed onto the motor 51; a small weight 54 was clamped to the bottom end of the core wire 53, which keeps the wire taut and straight in an up-down alignment. The motor 51 has a two-direction controller which allows the load 54 to move up or down. When the coating process is performed, a drop of coating liquid 55 was applied to the centre of the disc such that the wire 53 moves through it. During the movement of the core wire 53 the liquid was dragged with it, the solvent evaporates, and a coating layer was formed on the wire 53. Different coating layers were coated onto the core microwire 53 sequentially. The thickness of each coating layer could be adjusted by coating time controlled by the motor speed; a motor speed of 0.5 m/minute was used throughout experiment.

The time interval between coatings is 2 minutes for ink and gel electrolyte coatings. A number of coatings were carried out for each layer to get the desired thickness. For a simple single supercapacitor thread 10/4/4/2 times coatings were performed for the three active layers and the silver paint layer respectively. Ink, 10 wt % H₃PO₄/8.3 wt % PVA gel electrolyte, silver paint were used throughout experiment for each layer coating. The process was repeated to form a two capacitive layer supercapacitor.

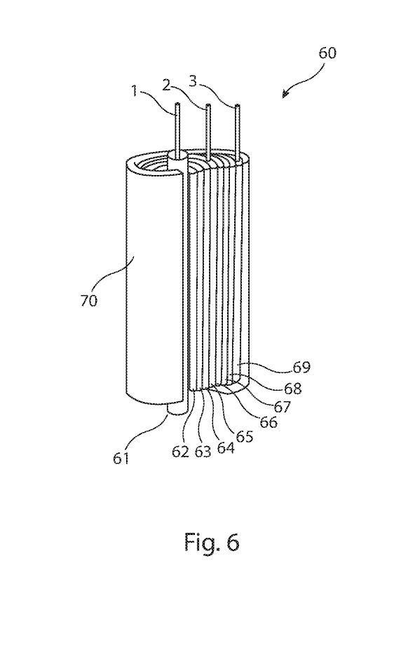

FIG. 6 shows the schematic of a coaxial two capacitive layers single fibre supercapacitor 60. It consists of two ink-gel-ink-silver paint capacitive layers. The first capacitive layer is formed of carbon ink 62, electrolyte gel 63, carbon ink 64 and silver paint 65 sub-layers. The second capacitive layer is formed of carbon ink 66, electrolyte gel 67, carbon ink 68 and silver paint 69 sub-layers. Leads 1,2,3 each formed of a spiral of 50 micron copper or stainless steel wire are embedded in core wire 61 and two silver paint layers 65,69 respectively to serve as current collectors. The embedded wires 1,2,3 reduce the resistance of the layers. Leads 1,2,3 could be connected in different ways depending on the circuit required.

With reference to FIG. 6, two capacitive layers could serve as two single supercapacitors by connecting into the circuit via leads 1 and 2or leads 1 and 3. To form two capacitors in parallel, leads 1 and 3 were connected together to form one pole of the capacitor and lead 2 forms the other. For two capacitors in series the multicapacitor was connected to leads 1 and 3; lead 2 was not connected but paint layer 65 served to make an internal connection between the capacitors.

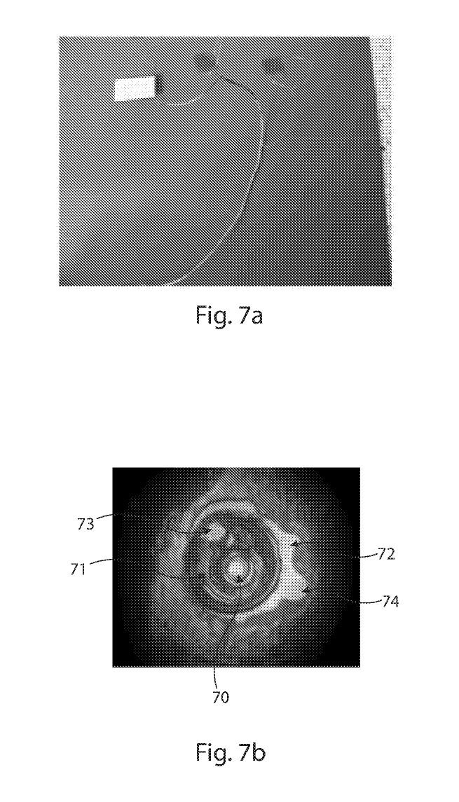

FIG. 7a shows the photo of a 4.3 cm long coaxial two capacitive layer single fibre supercapacitor. It has three stainless steel wire connections: one to the core 70 and two attached to the two silver paint layers 71,72. The total diameter of the multilayer thread is about a third of a millimetre. The cross section structure of a similar device with copper wires 73,74 instead of stainless steel wires embedded in the silver paint device was examined using an optical microscope (Olympus BHM, Trinocular MTV-3 with Nikon Coolpix 990 3.34 MP Digital Camera, Japan).

FIG. 7b shows a cross section image of the device. The sample was prepared by sealing a segment of the coaxial fibre supercapacitor in a liquid polymer mixture, leaving it for 24 hours for solidification, cut and then polished. As the carbon layers are soft, and the gel electrolyte layer is flexible, the cross section was slightly distorted after polishing. The coating layers are relatively uniform as shown in FIG. 7b. Average thicknesses are measured as 18 μm, 15 μm and 25 μm for the ink, gel electrolyte and ink in the inner capacitive layer respectively, and 18 μm, 10 μm and 20 μm for the ink, gel electrolyte and ink in the outer capacitive layer respectively. The diameter of the supercapacitor is 280 μm.

Results

Electrochemical measurements including cyclic voltammetry, galvanostatic charge-discharge and electrochemical impedance spectroscopy were conducted with a two-electrode setup using an electrochemical workstation VersaStat 3.0 (Princeton Applied Research). For electrochemical impedance measurements, a frequency range of 100 kHz-0.005 Hz with a 5 mV bias was employed.

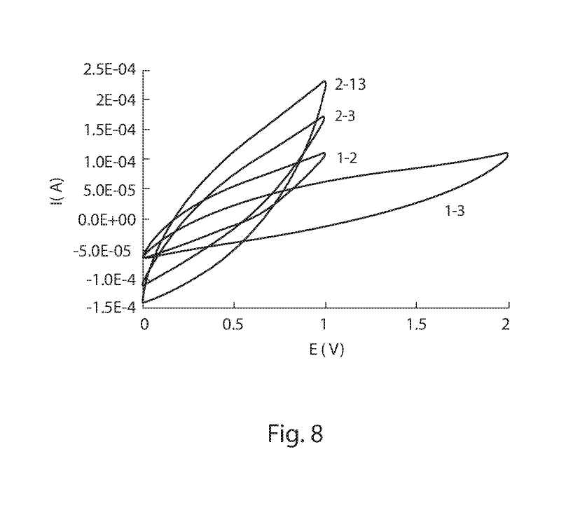

FIG. 8 shows typical cyclic voltammograms recorded at a scan rate of 50 mV/s for four different connections to the device:

Connections 1 and 2 (the inner capacitor, labelled on FIG. 8 as 1-2);

Connections 2 and 3 (the outer capacitor, labelled on FIG. 8 as 2-3);

Connections 2 and 1 and 3 connected together (two capacitors in parallel, labelled on FIG. 8 as 2-13); and

Connections 1 and 3 (two capacitors connected in series, labelled on FIG. 8 as 1-3).

It can be seen from FIG. 8 that the cyclic voltammograms were distorted from ideal square-box shape for all cases; this may result from ions' slow diffusion in porous carbon structure and a high series resistance. The parallel circuit (2-13) displayed larger capacitance and had a greater encircled area by the CV curve than those of two single capacitors; the series circuit (1-3) shows a larger potential window of 2V. The capacitance can be estimated using the following equation (1) from a cyclic voltammogram (CV)

C=A_{CV}/(v×V) (1)

Where C is the capacitance; ACV, the CV circled area; v, the scan rate and V, the potential window. Approximated capacitances for four circuits are 0.9, 1.3, 2.4 and 1.0 mF for circuits 1-2, 2-3, 2-13 and 1-3 respectively. No faradaic process was observed for all cases of electrical circuits indicating the gel electrolyte's stability in the system. The capacitance of a supercapacitor is dependent on the surface area of the electrodes and therefore is dependent on the mass of carbon coated. The greater the mass of carbon coated, the greater the capacitance. This is reflected in the observation that the inner capacitor has a smaller capacitance than the outer. The thickness may be the same but the mass or volume on the outer capacitor is greater as the volume of each layer is approximately 2 πrl where r is the average radius of the layer and l is the length of the thread.

Stored energy E can be calculated using equation (2):

E=1/2CV² (2):

0.45, 0.65, 1.2 and 4.0 mJ were obtained for 1-2, 2-3, 2-13 and 1-3 respectively, which demonstrated that the coaxial two capacitive layers fibre supercapacitor stored higher energy than single capacitors and when they were connected in parallel.

For the 1-3 series connection, as a single fibre supercapacitor, it was demonstrated that, with a PVA H₃PO₄ gel electrolyte, the device can be operated within 2V potential; if compared to single capacitive layer device of the same capacitance, its stored energy would be twice of that of single one based on the equation (2).

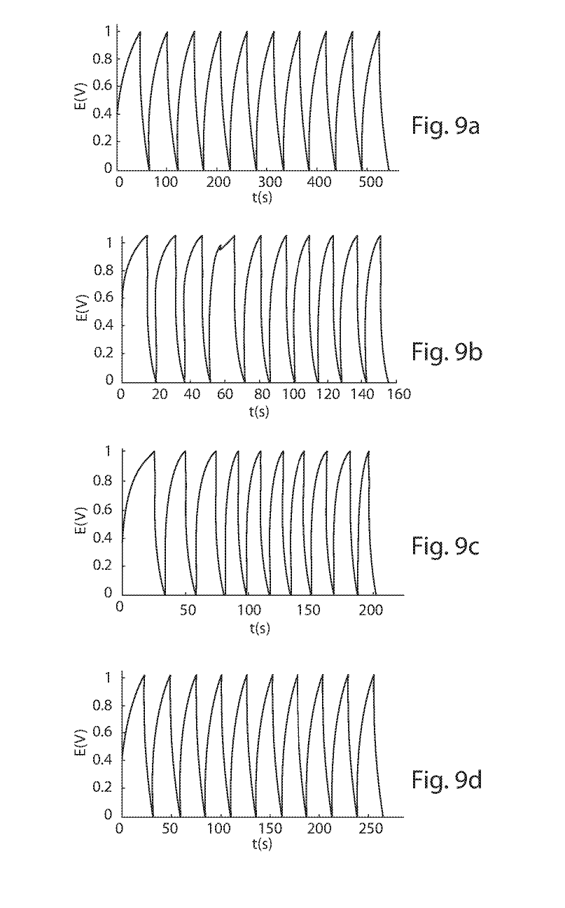

FIG. 9 shows typical galvanostatic charge-discharge curves for four circuits (a) 1-2 at charge-discharge 50 μA, (b) 2-3 at 80 μA, (c) 2-13 at 200 μA and 1-3 at 50 μA. Repetitive charge-discharge curves were observed for all cases. Differences in the first two cycles are seen and may be due to no zero open circuit potentials resulting from different sizes of electrode and materials of current collectors.

The specific capacitance per unit length was obtained using the equation

C_{L}=I Δt/(L(E−iR_{drop})) (3),

where l is the charge-discharge current (A); Δt the discharge time (s); L the supercapacitor length (cm); and E the potential window (V). The value of C_{L} was calculated as 1.26, 0.88, 1.66and 0.75 mF for 1-2, 2-3, 2-13 and 1-3 respectively.

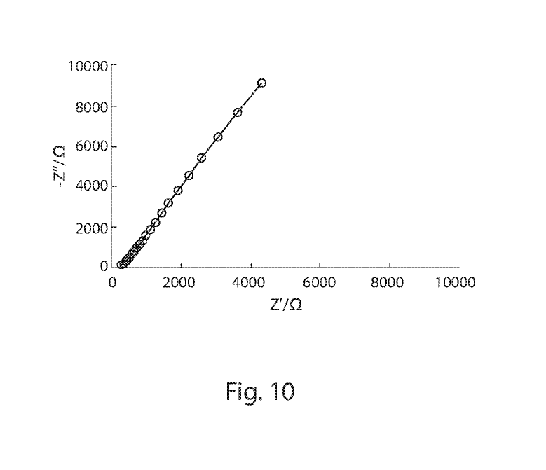

FIG. 10 is a Nyquist plot recorded for the 1-3 capacitor of the 4.3 cm long coaxial two capacitive layer single fibre supercapacitor at open circuit potential using a 5 mV AC modulation for a frequency ranged from 100 kHz to 0.005 Hz. This shows the electrochemical impedance spectrum for a range of frequencies from 100 kHz down to 0.01 Hz using AC 5 mV potential modulation. A pure capacitance trend was noted as expected from a transmission line model; no semicircle shape at high frequency ranges was observed, which would have resulted from interface processes of active layers and the current collectors and porous carbon electronic structure. Series resistance of 25Ωwas determined. The characteristic frequency f₀ is 0.32 Hz for a phase angle −45°. This frequency represents the point at which the resistive and capacitive impedance are equal. The corresponding time constant is 3.1s compared with l0s for a conventional activated carbon supercapacitor.

In conclusion, we have developed a novel coaxial two capacitive layer single fibre supercapacitor with a high energy and extended potential window for the first time by using a dip coating method. The two capacitive layers were coated on a single stainless steel microwire sequentially. The fabrication procedures are robust, which has great potential for scale-up. Owing to its coaxial structure, the supercapacitor is lightweight, has excellent flexibility, a high energy density and a wide operating potential window. This device could be integrated with other portable electronics for self-powered back-up and with energy generators such as solar cells or piezoelectric devices. The concept and fabrication procedure is not only applicable to two capacitive layers and carbon-carbon symmetric configurations but also to many capacitive layers and asymmetric supercapacitors.

1. A supercapacitor comprising a single core having sequential coaxial layers of:
(i) a first electrode,
(ii) a gelled electrolyte which functions as a separator for the supercapacitor,
(iii) a second electrode, and
(iv) a conductor for collecting current.

2. A supercapacitor as claimed in claim 1, comprising the additional sequential coaxial layers of:
(v) a third electrode,
(vi) second gelled electrolyte which functions as a separator,
(vii) a fourth electrode, and
(viii) a second conductor for collecting current.

3. A supercapacitor as claimed in claim 1, wherein the layers extend around the entire circumference of the core.

4. A supercapacitor as claimed in claim 1 wherein the core is formed from a metal, a polymer, carbon, or any combination thereof.

5. A supercapacitor as claimed in claim 1. wherein the core is formed of stainless steel.

6. A supercapacitor as claimed in claim 1, wherein the electrodes independently comprise conductive carbon in the form of particles, powder, tubes, fibres or a polymer, or wherein the electrodes independently comprise a porous transition metal oxide, a porous conducting polymer, or a conducting or semi conducting porous inorganic salt.

7. A supercapacitor as claimed in claim 6, wherein the conductive carbon is in the form of particles having an average diameter of less than 70 μm.

8. A supercapacitor as claimed in claim 6, wherein the conductive carbon is suspended in a gel or a slurry.

9. A supercapacitor as claimed in claim 1, wherein the first electrode is formed from carbon based ink.

10. A supercapacitor as claimed in claim 1, wherein the electrodes are formed from an activated carbon slurry.

11. A supercapacitor as claimed in claim 1, wherein the gelled electrolyte is formed from a polymer or monomer and a conducting liquid.

12. A supercapacitor as claimed in claim 1, wherein the gelled electrolyte is formed from PVA-H₃PO₄—H₂O gel solution.

13. A supercapacitor as claimed in claim 1, wherein independently the thickness of each electrolyte layer is from 10 micron to 1000 micron, the ehickness of each conductor layer is from 10 micron to 1000 the thickness each electrode layer is from 10 micron to 1000 micron, and the thickness of each conductor layer is from 10 micron to 1000 micron.

14. A supercapacitor as claimed in claim 1, wherein the conductor layer comprises metallic paint.

15. A supercapacitor as claimed in claim 1, wherein the core is an electrically conducting fibre.

16. An article comprising a supercapacitor as claimed in claim 1.

17. An article comprising a plurality of supercapacitors as claimed in claim 1 woven together.

18. An article as claimed in claim 17, additionally comprising a plurality of photovoltaic fibres woven with the supercapacitor fibres.

19. A method of making a single fibre supercapacitor as claimed in claim 1, wherein said layers are formed on the core by means of dip coating, spray coating, brush coating, extrusion coating, electrodeposition, plasma coating, curtain coating, vacuum deposition or any combination thereof.
